(19) United States
(12) Patent Application Publication
(10) Pub. No.: US 2012/0211632 A1
(43) Pub. Date: Aug. 23, 2012

(54) SUPPORTING PEDESTAL AND RELATED ANTENNA SYSTEM

(76) Inventors: Lan-Chun Yang, Hsinchu (TW); Ming-Chan Lee, Hsinchu (TW); Hung-Yuan Lin, Hsinchu (TW); San-Yi Kuo, Hsinchu (TW); Wei-Te Chien, Hsinchu (TW)

(21) Appl. No.: 13/083,591

(22) Filed: Apr. 10, 2011

(30) Foreign Application Priority Data
Feb. 23, 2011 (TW) 100105967

(51) Int. Cl. F16M 11/20

(52) U.S. Cl. 248/397

(57) ABSTRACT

A supporting pedestal capable of adjusting an azimuth angle of an antenna system is disclosed in the present invention. The angle adjusting mechanism includes a main body and a tube. The main body includes a base, a first board and a second board. The first board and the second board are respectively disposed on two sides of the base. A first pivot hole and a first slot are formed on the first board. A second pivot hole is formed on the second board. The main body further includes a rib disposed on an edge of the base and connecting the first and second boards for preventing the first and second boards from bending relative to the base. The first and second pivot holes are respectively formed on the sides of the first and second boards adjacent to the rib. The tube pivots relative to the main body.

### BACKGROUND OF THE INVENTION

1. Field of the Invention

The present invention relates to a supporting pedestal capable of adjusting an angle of an antenna module, and more particularly, to a supporting pedestal capable of adjusting an angle of an antenna module rapidly and capable of being installed on a ground, a wall and an inclined roof.

2. Description of the Prior Art

For supporting an antenna module on a platform effectively (such as on a ground, a wall or an inclined roof), an antenna system includes a supporting device, such as a supporting pedestal, connecting to the antenna module and disposed on the platform. For example, the antenna module can be disposed on the ground, the wall or the inclined roof, and the antenna module ( ) is orientated to a satellite, and an azimuth of the antenna module can be adjusted according to signals from the satellite. A conventional supporting pedestal includes a tube and a pedestal. A pivot hole and a slot are formed on the pedestal, and the slot is around under the pivot hole. Therefore, the tube of the conventional supporting pedestal pivots on the pivot hole on the pedestal, and can pivot relative to the pedestal along the slot. However, a rotary range of the tube relative to the pedestal is limited. For example, the tube can not pivot to a position parallel to a bottom of the pedestal, and the antenna module can not be located at a position parallel to a vertical wall by a straight tube when the supporting pedestal is installed on the vertical wall. For solving the drawback, the conventional supporting pedestal further includes a curved tube for supporting the antenna module on the wall, the ground and the inclined roof in any conditions. Cost of the conventional supporting pedestal is increased due to the curved tube, accordingly.

### SUMMARY OF THE INVENTION

The present invention provides a supporting pedestal of adjusting an angle of an antenna module rapidly for solving above drawbacks.

According to the claimed invention, a supporting pedestal includes a pedestal. The pedestal includes a base and a first board disposed on a lateral side of the base. A first pivot hole and a first slot are formed on the first board, and a distance between the first pivot hole and each section of the first slot being constant. The pedestal further includes a second board disposed on the other lateral side of the base and opposite to the first board. A second pivot hole is formed on the second board. The pedestal further includes a rib disposed on an edge of the base and connecting to the first board and the second board for preventing the first board and the second board from bending relative to the base. The first pivot hole and the second pivot hole are respectively formed on lateral sides of the first board and the second board adjacent to the rib. The pedestal further includes a tube disposed between the first board and the second board. A pivoting hole is formed on the tube. The pedestal further includes a first pivoting component passing through the first pivot hole, the second pivot hole and the pivoting hole so that the tube pivots relative to the pedestal via the pivoting hole. The pedestal further includes a first locking component for passing through the first slot and fixing at a first locking hole on the tube when the tube pivots relative to the first board and the second board at a predetermined angle, so as to fix the tube relative to the first board and the second board.

According to the claimed invention, the first slot is a quarter arc slot.

According to the claimed invention, a second slot is further formed on the second board, a distance between the second pivot hole and each section of the second slot is constant, and two end points of the second slot and the second pivot hole are respectively three corner points of a right triangle.

According to the claimed invention, the supporting pedestal further includes a second locking component for passing through the second slot and fixing at a second locking hole on the tube when the tube pivots relative to the first board and the second board at a predetermined angle, so as to fix the tube relative to the first board and the second board.

According to the claimed invention, the second slot is a quarter arc slot.

According to the claimed invention, at least one fixing hole and a slot are formed on the base.

According to the claimed invention, the tube is a circular tube or a square tube.

According to the claimed invention, an antenna system includes an antenna module and a supporting pedestal for supporting the antenna module. The supporting pedestal includes a pedestal disposed on a platform. The pedestal includes a base and a first board disposed on a lateral side of the base. A first pivot hole and a first slot are formed on the first board, and a distance between the first pivot hole and each section of the first slot being constant. The pedestal further includes a second board disposed on the other lateral side of the base and opposite to the first board. A second pivot hole is formed on the second board. The pedestal further includes a rib disposed on an edge of the base and connecting to the first board and the second board for preventing the first board and the second board from bending relative to the base. The first pivot hole and the second pivot hole are respectively formed on lateral sides of the first board and the second board adjacent to the rib. The pedestal further includes a tube disposed between the first board and the second board. A pivoting hole is formed on the tube. The pedestal further includes a first pivoting component passing through the first pivot hole, the second pivot hole and the pivoting hole so that the tube pivots relative to the pedestal via the pivoting hole. The pedestal further includes a first locking component for passing through the first slot and fixing at a first locking hole on the tube when the tube pivots relative to the first board and the second board at a predetermined angle, so as to fix the tube relative to the first board and the second board.

The supporting pedestal of the present invention forms the pivot holes on the lateral sides of the board adjacent to the rib. Two ends of the slot and the pivot hole can be respectively three corner points of a right equilateral triangle, and two equilateral sides of the right equilateral triangle are respectively perpendicular and vertical to the base. Therefore, the pedestal of the present invention has small size and light weight, so as to decrease manufacturing cost and transportation cost of the supporting pedestal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an antenna system according to an embodiment of the present invention.

FIG. 2 is an exploded diagram of a supporting pedestal according to the embodiment of the present invention.

FIG. 3 is an assembly of the supporting pedestal according to the embodiment of the present invention.

### DETAILED DESCRIPTION

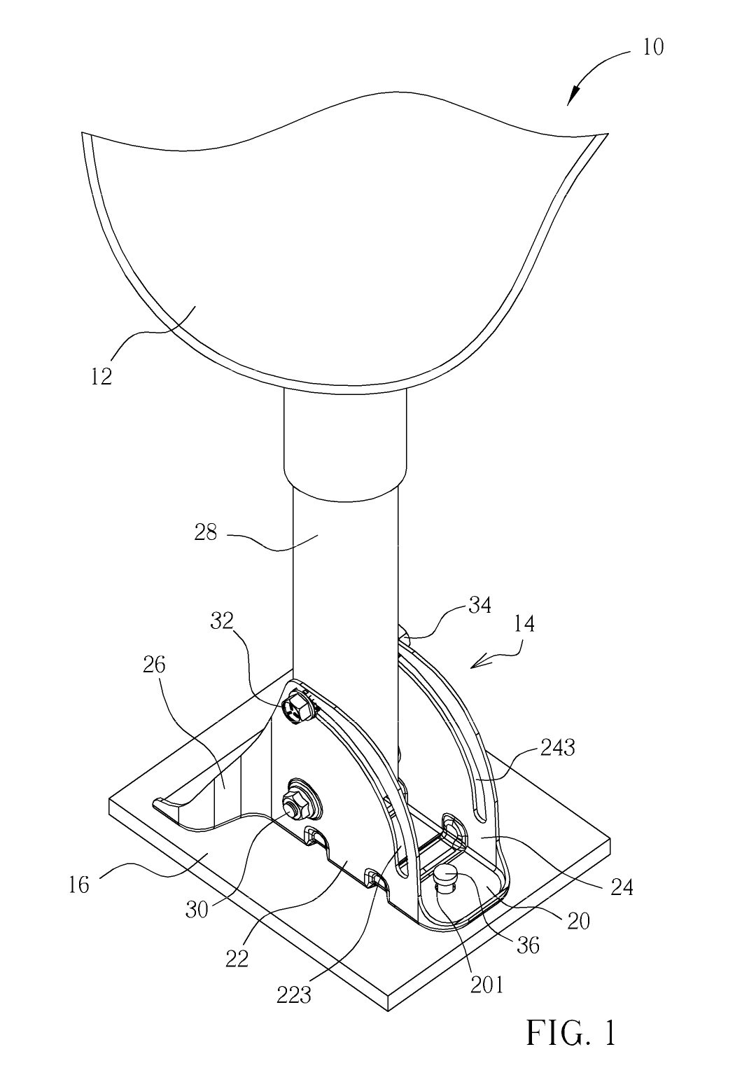

Please refer to FIG. 1. FIG. 1 is a diagram of an antenna system 10 according to an embodiment of the present invention. The antenna system 10 includes an antenna module 12 and a supporting pedestal 14. The supporting pedestal 14 is installed on a platform 16 (such as the ground, the wall or the inclined housetop) and is connected to the antenna module 12, and an angle of the antenna module 12 relative to the platform 16 oriented to a satellite (such as the azimuth) can be adjusted by the supporting pedestal 14 when the antenna system 10 is installed on the platform 16, so as to accurately orientate the antenna module 12 toward the satellite for receiving signals transmitted from the satellite.

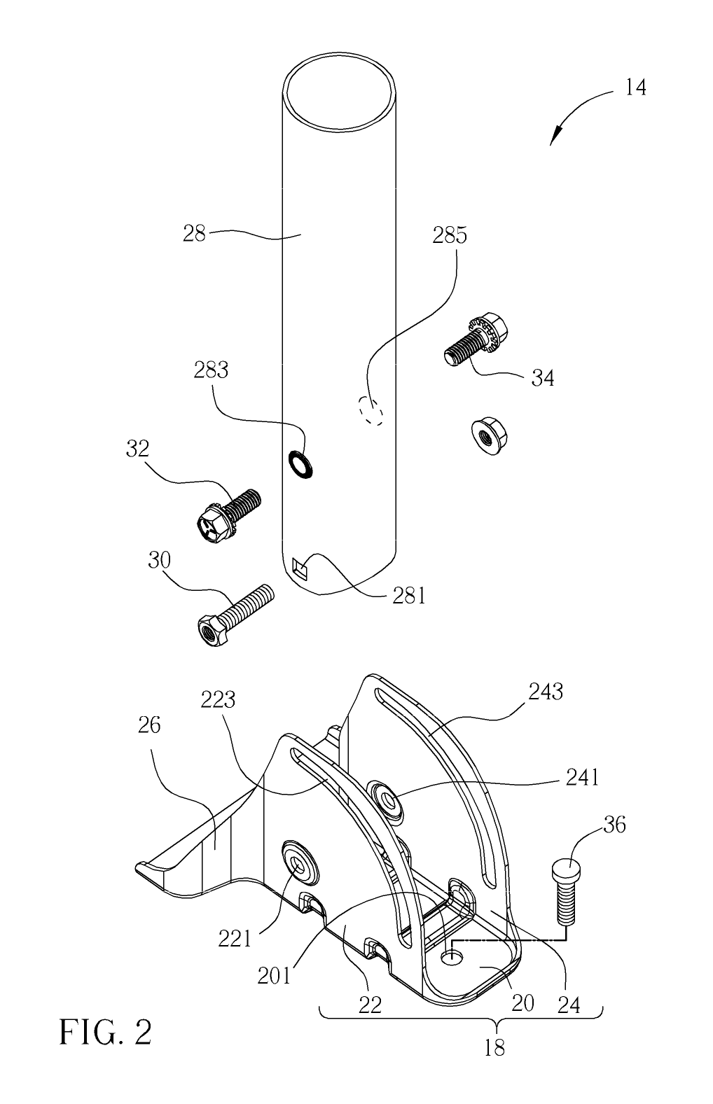

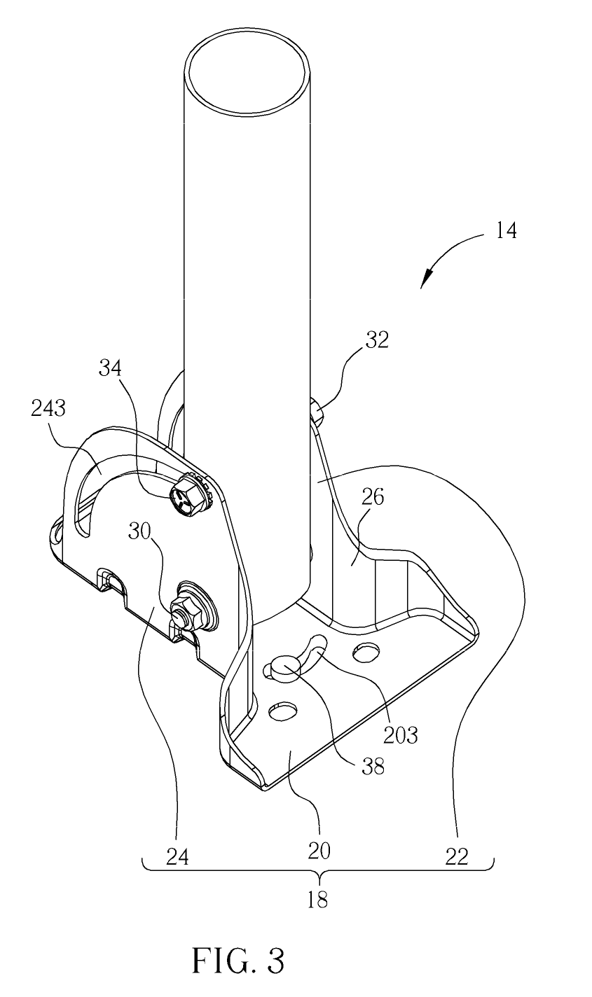

Please refer to FIG. 2 and FIG. 3. FIG. 2 is an exploded diagram of the supporting pedestal 14 according to the embodiment of the present invention. FIG. 3 is an assembly of the supporting pedestal 14 according to the embodiment of the present invention. The supporting pedestal 14 includes a pedestal 18 for disposing on the platform 16. The pedestal 18 includes a base 20 and a first board 22 disposed on a lateral side of the base 20. A first pivot hole 221 and a first slot 223 are formed the on the first board 22, and a distance between the first pivot hole 221 and each section of the first slot 223 are constant. The pedestal 18 further includes a second board 24 disposed on the other lateral side of the base 20 opposite to the first board 22. A second pivot hole 241 and a second slot 243 are formed on the second board 24, and a distance between the second pivot hole 241 and each section of the second slot 243 are constant. Positions of the second pivot hole 241 and the second slot 243 on the second board 24 correspond to positions of the first pivot hole 221 and the first slot 223 on the first board 22, and a shape of the second slot 243 corresponds to a shape of the first slot 223. The pedestal 18 further includes a rib 26 disposed on an edge of the base 20 and connected to the first board 22 and the second board 24 for preventing the first board 22 and the second board 24 from bending relative to the base 20, so as to increase structural strength. The first pivot hole 221 and the second pivot hole 241 are respectively formed on positions of the first board 22 and the second board 24 adjacent to the rib 26.

As shown in FIG. 2 and FIG. 3, the supporting pedestal 14 further includes a tube 28 connected to the antenna module 12 and disposed between the first board 22 and the second board 24. The tube 28 can be a circular tube or a square tube. A shape of the tube 28 is not limited to the above-mentioned embodiment, and it depends on design demand. A pivoting hole 281 is formed on the tube 28. The supporting pedestal 14 further includes a first pivoting component 30 passing through the first pivot hole 221, the second pivot hole 241 and the pivoting hole 281, so that the tube 28 can pivot relative to the pedestal 18 via the pivoting hole 281. The supporting pedestal 14 further includes a first locking component 32 for passing through the first slot 223 and being fixed at a first locking hole 283 on the tube 28 when the tube 28 pivots relative to the first board 22 and the second board 24 at a predetermined angle, so as to fix the tube 28 relative to the first board 22 and the second board 24. The first slot 223 can be a quarter arc slot, so that a range of the tube 28 pivoting relative to the pedestal 18 can be substantially between 0 degree and 90 degrees. Correspondingly, two end points of the first slot 223 and the first pivot hole 221 can respectively be three corner points of a right triangle, and two end points of the second slot 243 and the second pivot hole 241 can respectively be three corner points of the right triangle, which means the first slot 223 and the second slot 243 can respectively be a quarter arc slot. In addition, the supporting pedestal 14 can further include a second locking component 34 for passing through the second slot 243 and being fixed at a second locking hole 285 on the tube 28 when the tube 28 pivots relative to the first board 22 and the second board 24 at the predetermined angle, so as to fix the tube 28 relative to the first board 22 and the second board 24 with the first locking component 32. Thus, the supporting pedestal 14 can be for fixing the antenna module 12 relative to the platform 16 when the antenna module 12 is adjusted at a preferred azimuth.

Besides, as shown in FIG. 1 to FIG. 3, at least one fixing hole 201 and a slot 203 can be formed on the base 20. The antenna system 10 can further includes a fixing component 36 and a guiding component 38. The fixing component 36 can be for passing through the fixing hole 201 on the base 20 and for locking on the platform 16, so as to fix the pedestal 18 on the platform 16. The guiding component 38 can be for passing through the slot 203 on the base 20 and for fixing at the platform 16, so that the supporting pedestal 14 can be rotated relative to the platform 16 via the fixing hole 201 and along the slot 203, so as to adjust the antenna system 10 at a preferred position.

In conclusion, the supporting pedestal 14 of the present invention forms the pivot holes (the first pivot hole 221 and the second pivot hole 241) on positions of the boards (the first board 22 and the second board 24) adjacent to the base 20 and the rib 26, and forms the slots (the first slot 223 and the second slot 243) surrounding the pivot holes on the boards as the quarter arc, so that the tube 28 can pivot relative to the pedestal 18 along the slots. For example, when the tube 28 slides to ends of the first slot 223 and the second slot 243 adjacent to the base 20 along the first slot 223 and the second slot 243, an axial direction of the tube 28 can be parallel to the base 20, which means the tube 28 is parallel to the platform 16. When the tube 28 slides to the other ends of the first slot 223 and the second slot 243 away from the base 20 along the first slot 223 and the second slot 243, the axial direction of the tube 28 can be perpendicular to the base 20, which means the tube 28 is perpendicular to the platform 16. Therefore, the supporting pedestal 14 of the present invention can utilize a straight tube (a non-curved tube) to support the antenna module 12 for adjusting the angle of the antenna module 12 relative to the platform 16 within 0 degree to 90 degrees. Furthermore, pivot of the tube 28 and the pedestal 18 of the present invention is located adjacent to the rib 26, so as to increase the structural strength of the supporting pedestal 14 for preventing the first board 22 and the second board 24 of the pedestal 28 from bending relative to the base 20 due to overweight of the antenna module 12.

Comparing to the prior art, the supporting pedestal of the present invention forms the pivot holes on the lateral sides of the board adjacent to the rib. Two ends of the slot and the pivot hole can be respectively three corner points of a right equilateral triangle, and two equilateral sides of the right equilateral triangle are respectively perpendicular and vertical to the base. Therefore, the pedestal of the present invention has small size and light weight, so as to decrease manufacturing cost and transportation cost of the supporting pedestal.

Those skilled in the art will readily observe that numerous modifications and alterations of the device and method may be made while retaining the teachings of the invention.

What is claimed is:

1. A supporting pedestal comprising:
a pedestal comprising:
a base;
a first board disposed on a lateral side of the base, a first pivot hole and a first slot being formed on the first board, and a distance between the first pivot hole and each section of the first slot being constant;
a second board disposed on the other lateral side of the base and opposite to the first board, a second pivot hole being formed on the second board; and
a rib disposed on an edge of the base and connecting to the first board and the second board for preventing the first board and the second board from bending relative to the base, the first pivot hole and the second pivot hole being respectively formed on lateral sides of the first board and the second board adjacent to the rib;
a tube disposed between the first board and the second board, a pivoting hole being formed on the tube;
a first pivoting component passing through the first pivot hole, the second pivot hole and the pivoting hole so that the tube pivots relative to the pedestal via the pivoting hole; and
a first locking component for passing through the first slot and fixing at a first locking hole on the tube when the tube pivots relative to the first board and the second board at a predetermined angle, so as to fix the tube relative to the first board and the second board.

2. The supporting pedestal of claim 1, wherein the first slot is a quarter arc slot.

3. The supporting pedestal of claim 1, wherein a second slot is further formed on the second board, a distance between the second pivot hole and each section of the second slot is constant, and two end points of the second slot and the second pivot hole are respectively three corner points of a right triangle.

4. The supporting pedestal of claim 3, further comprising:
a second locking component for passing through the second slot and fixing at a second locking hole on the tube when the tube pivots relative to the first board and the second board at a predetermined angle, so as to fix the tube relative to the first board and the second board.

5. The supporting pedestal of claim 3, wherein the second slot is a quarter arc slot.

6. The supporting pedestal of claim 1, wherein at least one fixing hole and a slot are formed on the base.

7. The supporting pedestal of claim 1, wherein the tube is a circular tube or a square tube.

8. An antenna system comprising:
an antenna module; and
a supporting pedestal for supporting the antenna module, the supporting pedestal comprising:
a pedestal disposed on a platform, the pedestal comprising:
a base;
a first board disposed on a lateral side of the base, a first pivot hole and a first slot being formed on the first board, and a distance between the first pivot hole and each section of the first slot being constant;
a second board disposed on the other lateral side of the base and opposite to the first board, a second pivot hole being formed on the second board; and
a rib disposed on an edge of the base and connecting to the first board and the second board for preventing the first board and the second board from bending relative to the base, the first pivot hole and the second pivot hole being respectively formed on lateral sides of the first board and the second board adjacent to the rib;
a tube connected to the antenna module and disposed between the first board and the second board, a pivoting hole being formed on the tube;
a first pivoting component passing through the first pivot hole, the second pivot hole and the pivoting hole so that the tube pivots relative to the pedestal via the pivoting hole; and
a first locking component for passing through the first slot and fixing at a first locking hole on the tube when the tube pivots relative to the first board and the second board at a predetermined angle, so as to fix the tube relative to the first board and the second board.

9. The antenna system of claim 8, wherein the first slot is a quarter arc slot.

10. The antenna system of claim 8, wherein a second slot is further formed on the second board, a distance between the second pivot hole and each section of the second slot are constant, and two end points of the second slot and the second pivot hole are respectively three corner points of a right triangle.

11. The antenna system of claim 10, wherein the supporting pedestal further comprises:
a second locking component for passing through the second slot and fixing at a second locking hole on the tube when the tube pivots relative to the first board and the second board at a predetermined angle, so as to fix the tube relative to the first board and the second board.

12. The antenna system of claim 10, wherein the second slot is a quarter arc slot.

13. The antenna system of claim 8, wherein at least one fixing hole and a slot are formed on the base, the antenna system further comprises a fixing component for passing through the fixing hole and locking on the platform, and a guiding component for passing through the slot and fixing at the platform, so that the supporting pedestal rotates relative to the platform via the fixing hole and along a direction of the slot.

14. The antenna system of claim 8, wherein the tube is a circular tube or a square tube.
